(19) United States
(12) Patent Application Publication
(10) Pub. No.: US 2008/0256419 A1
(43) Pub. Date: Oct. 16, 2008

(54) Configurable Split Storage of Error Detecting and Correcting Codes

(75) Inventors: Igor Wojewoda, Tempe, AZ (US); Kobus Marneweck, San Diego, CA (US)

Correspondence Address: Baker Botts L.L.P.;One Shell Plaza, 910 Louisiana Street, Houston, TX, 77002-4995, US

(73) Assignee: Microchip Technology Incorporated

(21) Appl. No.: 11/735,243

(22) Filed: Apr. 13, 2007

(51) Int. Cl. G06F 11/00

(52) U.S. Cl. 714/766

(57) ABSTRACT

Memory space of a digital device may be configured for both instructions/data (op-code) and ECC or parity when required, otherwise the entire memory space may be configured for just the program instructions/data. A standard word width memory may be configured for ECC or non-ECC functionality, or parity or non-parity functionality, based upon a desired application. The last portion of the memory may be allocated for ECC or parity data rather then application code when an ECC or parity implementation is required. When an ECC or parity implementation is not required, the entire memory may be used for the application code. This allows a digital device and memory to be used in applications having different robustness (e.g., application code integrity) requirements without have to fabricate different digital devices.

### TECHNICAL FIELD

The present disclosure relates to memory configuration for a digital device, and more particularly, to a configurable memory for storage of program instructions and/or data (op-codes), with selectable storage of error detecting and correcting codes.

### BACKGROUND

In digital devices having processors controlled by program instructions, typical error correcting code (ECC) or parity checking implementations store the ECC or parity data as part of an operation code (op-code) word. Such implementations require a wider word program memory, i.e., more bits per memory location, to accommodate the extra ECC or parity data. However, for applications where ECC or parity is not required, memory capacity is wasted because of the unused extra memory word bits set aside for the ECC or parity data.

### SUMMARY

Therefore there is a need for a digital device having a memory space that may be configured for an ECC or parity implementation when required, otherwise the entire memory space may be made available for program instructions and/or data (op-code) with digital devices not requiring ECC or parity checking. According to teachings of this disclosure, standard size, e.g., standard word width, memory, e.g., FLASH, electrically programmable read only memory (EEPROM), battery backed-up random access memory (RAM), etc., may be configured for ECC or non-ECC functionality, or parity or non-parity functionality, based upon a desired digital device application. The last portion of the memory may be allocated for ECC or parity data rather then op-code storage when an ECC or parity implementation is required. When an ECC or parity implementation is not required, the entire memory may be used for op-code (e.g., program instructions and/or data) storage. This allows the memory of the digital device to be used most efficiently in applications having different robustness (e.g., application code integrity) requirements.

When ECC or parity checking is implemented in a digital device, according to specific example embodiments of this disclosure, the ECC or parity data may be stored at the end of the memory and may be fetched as needed for each op-code word. This requires extra read cycles out of the memory, but will not be an issue when headroom exists for the speed of program execution. Thus digital processing for either ECC/parity or non-ECC/non-parity applications may be provided using only one type of digital device memory without incurring additional hardware costs.

A parity implementation, e.g., even or odd parity, may detect single-bit errors but cannot correct an error. However, the parity implementation has minimal overhead, e.g., only one extra bit is used per instruction and/or data word. The parity bits may be stored at the end of the memory, in groups of N for N bit op-codes (assuming an N-bit wide memory word), e.g., groups of 24 for 24 bit application codes. Thus parities for up to N words may be loaded into an N-bit wide cache with one memory read access. When loading the parity bits into cache, a very small reduction in execution speed may result, e.g., for a 24-bit word, a 4 percent speed reduction may result.

A single-bit error correction double error detection error correcting code (SECDED ECC) can detect and correct single-bit errors, and detect 2-bit errors. The SECDED ECC requires an overhead of 6-bits to detect and correct a single-bit error in a 24-bit word. For a 24-bit memory word this implies a 25 percent reduction of memory available for op-code storage. The 6-bit ECC error correcting code for each 24-bit op-code word may be stored at the end of the memory in groups of four (4×6 bits=24 bits). Thus, up to four words worth of error correcting code may be loaded into cache per memory access. For sequential program execution, one extra memory access for every four op-code word accesses will be required (cache stores four error correcting codes per each memory read access), this will reduce program execution speed by about 20 percent.

According to a specific example embodiment of this disclosure, a digital device having a configurable memory may comprise: a digital processor; a main memory in communication with the digital processor; an op-code latch for storing an operational code (op-code) word read from the main memory; and parity check logic coupled to the main memory, op-code latch and the digital processor, whereby the parity check logic determines whether the op-code word stored in the op-code latch has a parity error; wherein the main memory is configurable for storing operational code (op-code) words and parity bits, or op-code words only.

According to another specific example embodiment of this disclosure, a digital device having a configurable memory may comprise: a digital processor; a main memory in communication with the digital processor; an op-code latch for storing an operational code (op-code) word read from the main memory; and error correcting code (ECC) logic coupled to the main memory, op-code latch and the digital processor, whereby the ECC logic determines whether the op-code word stored in the op-code latch has an error and attempts to correct the error; wherein the main memory is configurable for storing op-code words and ECC data words, or op-code words only.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of a digital device comprising a digital processor, a memory with configurable storage space, a parity or ECC cache and associated logic, and an op-code latch, according to specific example embodiments of this disclosure;

FIG. 2 is a schematic flow diagram for parity checking operation of the digital device of FIG. 1, according to one of the specific example embodiments of this disclosure;

FIG. 3 is a schematic flow diagram for ECC operation of the digital device of FIG. 1, according to another one of the specific example embodiments of this disclosure; and

FIG. 4 is a more detailed schematic block diagram of a portion of the digital device of FIG. 1.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of specific example embodiments are schematically illustrated. Like elements in the drawings will be represented by like numbers, and similar elements will be represented by like numbers with a different lower case letter suffix.

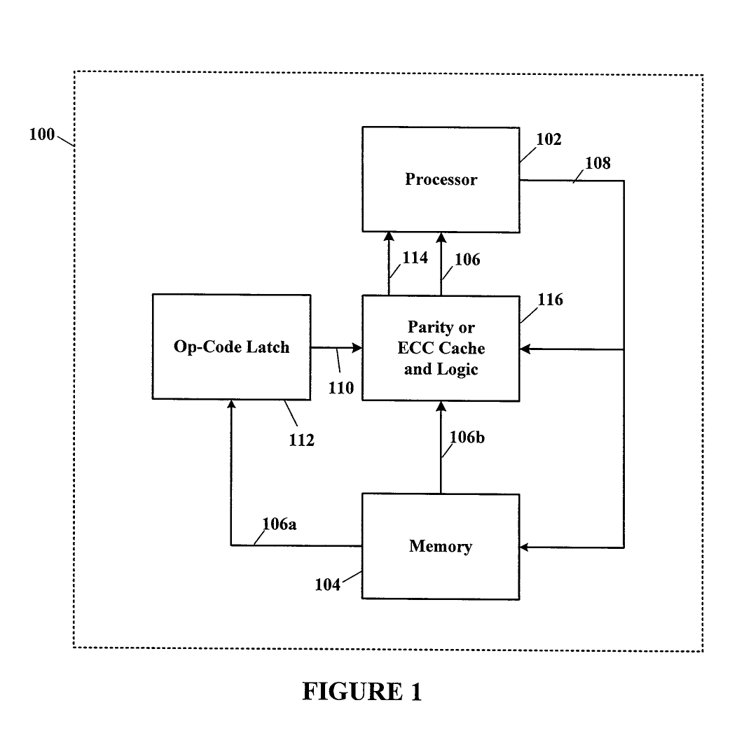

Referring to FIG. 1, depicted is a digital device comprising a digital processor, a memory with configurable storage space, a parity or ECC cache and associated logic, and an op-code latch, according to specific example embodiments of this disclosure. A digital device 100 may comprise a processor 102, a parity or ECC cache 116, a memory 104 and an op-code latch 112. The processor 102, e.g., microprocessor, microcontroller, digital signal process, application specific integrated circuit (ASIC), programmable logic array (PLA), etc., may send addresses to retrieve program instructions and/or data (e.g., op-codes) on an address bus 108 to the memory 104 and cache and logic 116. When the memory 104 receives an address from the processor 102 over the address bus 108 it returns the op-code located in that address to the op-code latch 112 over the data bus 106a. A second address representing the location of the parity bit or ECC data word is subsequently asserted on the address bus 108 to retrieve a plurality of parity bits or ECC data words, one of which is associated with the addressed op-code. The retrieved plurality of parity bits (a number of parity bits equal to the number of bits in the memory word in which the associated parity bit is located) or ECC data words are stored in the cache and logic 116 if they have not been previously stored therein. The op-code is read from the op-code latch 112 over bus 110, and a parity or ECC check thereof is made in the cache and logic 116. The parity checked or ECC checked (and corrected if necessary) op-code is presented to the processor 102 over bus 106. An error signal 114 may be sent to the processor 102, and upon receipt of the error signal 114, the processor 102 may halt further operation. When parity checking is not required, the entire memory 104 may be used to store op-codes, e.g., program instruction and/or data. The digital device 100 may be fabricated on an integrated circuit die and the integrated circuit die may be enclosed in an integrated circuit package (not shown).

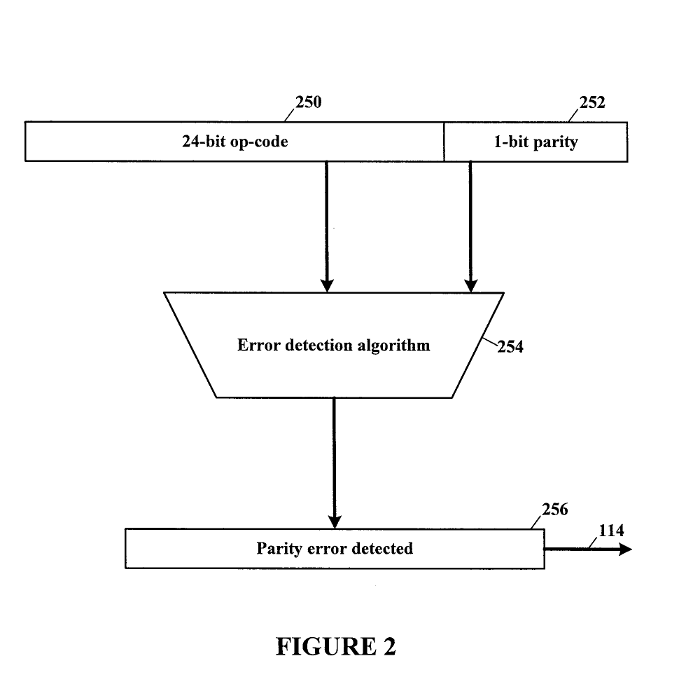

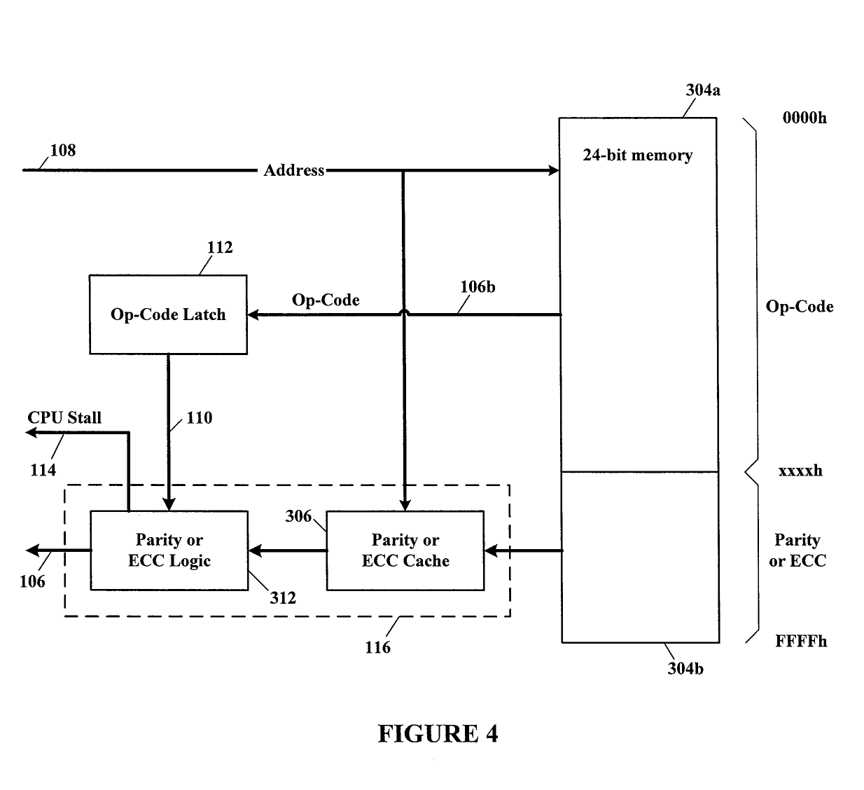

Referring to FIG. 2, depicted is a schematic flow diagram for parity checking operation of the digital device of FIG. 1, according to one of the specific example embodiments of this disclosure. The program instruction and/or data word 250, e.g., 24-bit op-code, and the 1-bit parity 252 may be checked with an error detection algorithm in step 254 by the cache and logic 116 (e.g., parity check logic 312 (FIG. 4)). If for step 252, the 1-bit parity must be fetched from the memory 104 (not in the cache 116), or if a parity error is detected in step 256 then a stall or error signal 114 may be sent to the digital processor 102. Upon receipt of this stall or error signal 114, the digital processor 102 may stall or halt further operation.

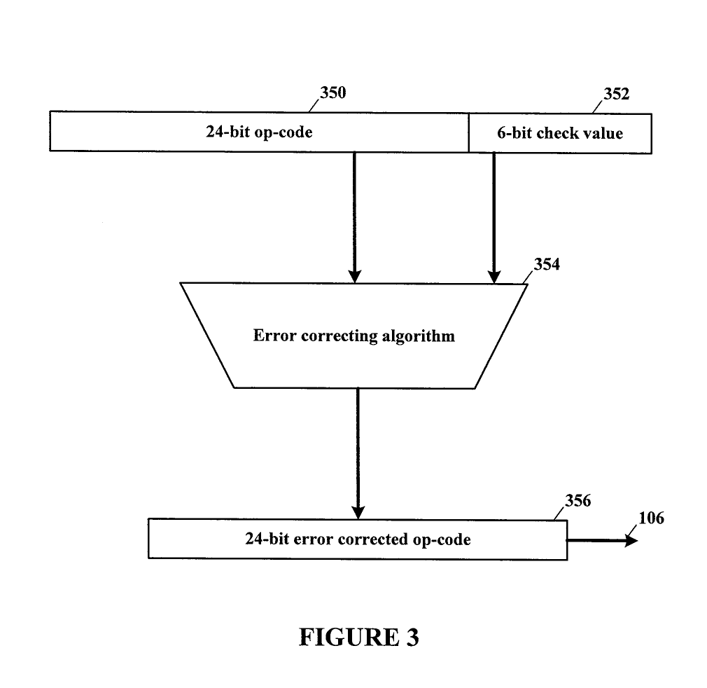

Referring to FIG. 3, depicted is a schematic flow diagram for ECC operation of the digital device of FIG. 1, according to another one of the specific example embodiments of this disclosure. The program instruction and/or data word 350, e.g., 24-bit op-code, and the ECC data 352, e.g., 6-bit check value, may be applied in step 354 by the ECC logic 312 (FIG. 4) to produce an error corrected program instruction and/or data word 356, e.g., 24-bit error corrected op-code. This error corrected op-code 356 may then be sent to the digital processor 102 over the data bus 106. If for step 352, the 6-bit check value must be fetched from the memory 104 (not in the cache 116), then the stall or error signal 114 may be sent to the digital processor 102 so that the digital processor 102 may stall until the 6-bit check value is available for use in step 354.

Referring to FIG. 4, depicted is a more detailed schematic block diagram of a portion of the digital device of FIG. 1. A processor 102 (FIG. 1) may be coupled to a memory 304 having an instruction/data (op-code) portion 304a and a parity or ECC portion 304b. The digital processor 102 requests an op-code from the memory portion 304a on the address bus 108. This op-code will be stored (latched) in the op-code latch 112. Next, the digital processor 102 requests an associated parity bit or ECC data word for the op-code stored in the op-code latch 112. If the associated parity bit or ECC data word is already stored in the parity or ECC cache 306, then the parity or ECC logic 312 may immediately process the op-code stored in the op-code latch with the parity bit or ECC data word to produce a checked op-code to the processor 102 over bus 106.

However, if the associated parity bit or ECC data word is not stored in the parity or ECC cache 306, then the processor 102 has to fetch the associated parity bit or ECC data word from the memory portion 304b. This extra memory access will slow down the parity or ECC check, and for very fast processors, issuing a CPU stall 114 may be desired until the op-code and associated parity bit or ECC data word are available for processing in the parity or ECC logic 312. The aforementioned digital device of FIGS. 1 and 4 may be fabricated on an integrated circuit die and the integrated circuit die may be enclosed in an integrated circuit package (not shown). When parity or ECC checking is not required, the entire memory 304 may be used to op-codes.

An ECC cache may not be required if there is sufficient headroom with the application. Thus, the op-code 350 may be read on one memory read cycle and the parity bits or ECC data 352 on the next memory read cycle. This will require about twice the memory read access time as a non-ECC implemented solution but does not require any special new logic implementation in existing digital devices 100. For example, a typical instruction memory read operation may include (1) fetch op-code word, (2) fetch the parity or ECC data associated with the op-code just fetched, (3) apply the parity or ECC algorithm to the fetched op-code word and parity or ECC data, and (4) present checked (and corrected) op-code word for use by the digital processor 102.

For faster processors having ECC implementations, a stall function 314 may be applied to the central processing unit (CPU) of the digital processor 102 so that the ECC data may be retrieved during the instruction cycle. This requires an ECC cache 306 but ECC data for multiple program instruction and/or data words may be retrieved and stored in the ECC cache 306. E.g., a 24-bit wide memory word will supply four 6-bit ECC data words for each memory read operation. For example, (1) assert new opcode address, (2) after address stable compare with what is stored in ECC cache, if a cache miss, stall CPU, (3) fetch ECC data from memory during CPU stall, (4) ECC corrected program instruction and/or data word available to CPU, and (5) unstall CPU to decode the ECC corrected program instruction and/or data word.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A digital device having a configurable memory, comprising:
a digital processor;
a main memory in communication with the digital processor;
an op-code latch for storing an operational code (op-code) word read from the main memory; and
parity check logic coupled to the main memory, op-code latch and the digital processor, whereby the parity check logic determines whether the op-code word stored in the op-code latch has a parity error;
wherein the main memory is configurable for storing operational code (op-code) words and parity bits, or op-code words only.

2. The digital device according to claim 1, further comprising a parity cache coupled between the main memory and the parity check logic, wherein the parity cache stores a plurality of parity bits read from the main memory.

3. The digital device according to claim 1, wherein the digital processor will halt operation if the parity check logic indicates a parity error in the op-code word retrieved from the main memory.

4. The digital device according to claim 1, wherein the digital processor is a microcontroller.

5. The digital device according to claim 1, wherein the digital processor is a microprocessor.

6. The digital device according to claim 1, wherein the digital processor is a digital signal processor.

7. The digital device according to claim 2, wherein the digital processor, parity cache, main memory and parity check logic are fabricated on an integrated circuit die.

8. The digital device according to claim 7, wherein the integrated circuit die is enclosed in an integrated circuit package.

9. The digital device according to claim 1, wherein the parity check logic is disabled when the main memory is configured for storing op-code words only.

10. The digital device according to claim 2, wherein the plurality of parity bits are stored in the parity cache during a single read operation from the main memory.

11. The digital device according to claim 10, wherein the parity check logic checks the parity cache for a parity bit associated with the op-code word before doing another read from the main memory.

12. The digital device according to claim 10, wherein the parity check logic compares the calculated parity with the parity bit in the cache associated with the op-code word and forces a halt or reset action if the parity check fails.

13. A digital device having a configurable memory, comprising:
a digital processor;
a main memory in communication with the digital processor;
an op-code latch for storing an operational code (op-code) word read from the main memory; and
error correcting code (ECC) logic coupled to the main memory, op-code latch and the digital processor, whereby the ECC logic determines whether the op-code word stored in the op-code latch has an error and attempts to correct the error;
wherein the main memory is configurable for storing op-code words and ECC data words, or op-code words only.

14. The digital device according to claim 13, further comprising an ECC cache coupled between the main memory and the ECC logic, wherein the ECC cache stores a plurality of ECC data words read from the main memory.

15. The digital device according to claim 13, wherein the ECC logic will correct the op-code word read from the program memory having a one bit error and halt operation of the digital processor on two or more bit errors.

16. The digital device according to claim 13, wherein the digital processor is a microcontroller.

17. The digital device according to claim 13, wherein the digital processor is a microprocessor.

18. The digital device according to claim 13, wherein the digital processor is a digital signal processor.

19. The digital device according to claim 14, wherein the digital processor, ECC cache, main memory and ECC logic and are fabricated on an integrated circuit die.

20. The digital device according to claim 19, wherein the integrated circuit die is enclosed in an integrated circuit package.

21. The digital device according to claim 13, wherein the ECC logic is disabled when the main memory is configured for storing op-code words only.

22. The digital device according to claim 13, wherein a plurality of ECC data words are stored in the ECC cache during a single read operation from the main memory.

23. The digital device according to claim 22, wherein the ECC logic checks the ECC cache for an ECC data word associated with the op-code word before doing another read from the main memory.

24. The digital device according to claim 22, wherein the ECC logic compares the calculated ECC value with the ECC value in the cache associated with the op-code word and sets a flag and corrects the op-code word before execution thereof if a single bit error is detected, otherwise if a double bit error is detected the digital device will force a halt or reset.
